(19) United States
(12) Patent Application Publication
(10) Pub. No.: US 2003/0030233 A1
(43) Pub. Date: Feb. 13, 2003

(54) Closure stopper

(76) Inventors: Martin Benzinger, Michelstadt (DE); Andreas Szeteli, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/220,438

(22) PCT Filed: Feb. 2, 2001
(86) PCT No.: PCT/EP01/01120

(30) Foreign Application Priority Data
Mar. 1, 2000 (DE) 10009895.9

(51) Int. Cl. F16J 15/46

(52) U.S. Cl. 277/628

(57) ABSTRACT

The invention relates to a closure stopper for containers of liquids, which is configured as a one-piece plastic part. A central degasifying vent (6) is covered on the inside by a bonded-fibre filter (7). An expansion-resistant wall (5) projects from the inner side (1a) of a ceiling wall (1) that surrounds the degasifying vent (6) on all sides at a distance. The bonded-fibre filter (7) is fixed to a protrusion (8) that is melted onto base of the expansion-resistant wall (5).

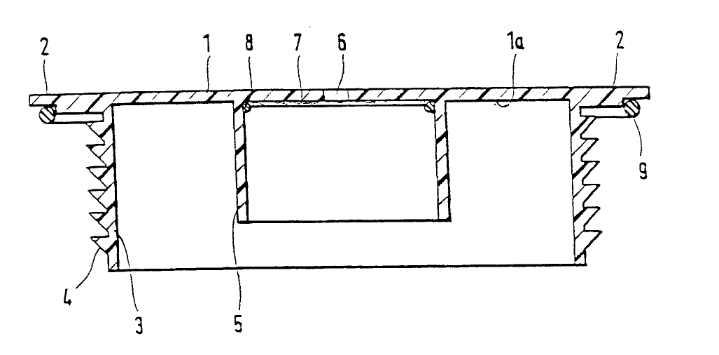

The invention relates to a sealing stopper for liquid containers, having in a top wall a vent opening covered by a nonwoven filter material on its inside.

Sealing stoppers of this type serve to seal containers, in particular transport containers, for liquids which evaporate or evolve gases as a consequence of their chemical nature and composition or under the influence of temperature. Complete, hermetic sealing of the container would result in an increase in the internal pressure in the container, which could result in damage to the container or at least in loosening of the closure, so that liquid would escape. This must be reliably prevented, in particular if the liquid present in the container is classified as a hazardous material or contamination of the liquid is feared on loosening of the closure.

Known sealing stoppers of the generic type mentioned at the outset are designed as two-piece screw stoppers. A sealing element inserted into the container opening to be sealed has a central hole with internal thread, into which a screw closure is screwed. The screw closure has a vent opening which is covered by a non-woven filter material. Gases or vapours formed in the interior of the container are able to escape through the non-woven filter material, preventing an undesired build-up of pressure. The fine-pore design of the non-woven filter material prevents escape of liquid if the liquid briefly reaches the sealing stopper during splash movements.

The known sealing stopper has a relatively complex design, in particular owing to its two-piece nature, and consequently the production expense necessary is relatively high.

The object of the invention is therefore to design a sealing stopper of the generic type mentioned at the outset in such a way that it is simple to produce and, while retaining the same function, offers effective protection even against the escape of liquid as a consequence of splash movements.

This object is achieved in accordance with the invention in that the sealing stopper is designed as a one-piece plastic part and has on its top wall a splash-protection wall projecting on the inside and surrounding the vent opening at a distance on all sides.

The one-piece design of the sealing stopper results in a significant simplification and reduction in production costs. Since an internal thread for accommodating a separate screw stopper is unnecessary, the splash-protection wall can be made thinner and at an optimum separation on the one hand from the vent opening and on the other hand from the body wall of the sealing stopper. As a consequence, wetting of the non-woven filter material is substantially prevented during splash movements of the accommodated liquid, so that no liquid escapes through the non-woven filter material, but it retains its gas permeability.

According to a preferred embodiment of the invention, it is provided that the non-woven filter material is in contact with the inside of the top wall and is secured by a bead melted on at the foot of the splash-protection wall. This facilitates very simple securing of the non-woven filter material from a manufacturing point of view, even if direct adhesive bonding of the non-woven filter material to the material of the sealing stopper is not possible or too complex for an efficient manufacturing process.

Further sub-claims relate to further advantageous embodiments of the inventive idea.

A working example of the invention is explained in greater detail below and is depicted in the drawing.

The drawing shows a section through a sealing stopper for a liquid container. The sealing stopper is designed as a one-piece plastic part. It has an essentially planar top wall 1, whose edge 2 projects to the outside over a stopper body 3, which extends away from the inside 1a of the top wall 1 and is of essentially cylindrical design. The top wall 1 is connected in one piece to the stopper body 3 projecting on its inside 1a.

Circumferential beads 4 which are approximately triangular in cross section are provided on the outside of the stopper body 3, keeping the sealing stopper leak-proof and held by frictional force in the liquid container opening to be sealed.

A splash-protection wall 5, which is likewise preferably cylindrical, projects concentrically within the stopper body 3 on the inside 1a of the top wall 1. The splash-protection wall 5 surrounds a central vent opening 6 in the top wall 1 at a distance on all sides. The vent opening 6 is covered by a nonwoven filter material, which is in contact with the inside 1a of the top wall 1 and, in the illustrative example depicted, extends to the inner edge of the splash-protection wall 5.

The non-woven filter material 7 in contact with the inside 1a of the top wall 1 is secured by a circumferential bead 8 melted on at the foot of the splash-protection wall 5.

As indicated diagrammatically in the drawing, the edge 2 of the top wall 1 projecting radially over the stopper body 3 carries a sealing ring 9 on its inside.

1. Sealing stopper for a liquid container, having in a top wall a vent opening covered by a non-woven filter material on its inside, characterized in that the sealing stopper is designed as a one-piece plastic part and has on its top wall (1) a splash-protection wall (5) projecting on the inside (1a) and surrounding the vent opening (6) at a distance on all sides.

2. Sealing stopper according to claim 1, characterized in that the non-woven filter material (7) is in contact with the inside (1a) of the top wall (1) and is secured by a bead (8) melted on at the foot of the splash-protection wall (5).

3. Sealing stopper according to claim 1, characterized in that the top wall (1) is connected in one piece to a stopper body (3) projecting on its inside (1a).

4. Sealing stopper according to claim 3, characterized in that the edge of the top wall (1) projects radially over the stopper body (3) and carries a sealing ring (9) on its inside.
